(19) United States
(12) Patent Application Publication
(10) Pub. No.: US 2009/0134551 A1
(43) Pub. Date: May 28, 2009

(54) Mouldable material

(76) Inventor: Jane Mary Delehanty, London (GB)

Correspondence Address: DICKSTEIN SHAPIRO LLP, 1825 EYE STREET NW, Washington, DC, 20006-5403, US

(21) Appl. No.: 11/921,005

(22) PCT Filed: May 26, 2006
(86) PCT No.: PCT/GB2006/001926

§ 371 Date: May 2, 2008

(30) Foreign Application Priority Data
May 27, 2005 (GB) 0510949.1
Dec. 22, 2005 (GB) 0526179.7

(51) Int. Cl. B28B 1/14

(52) U.S. Cl. 264/299

(57) ABSTRACT

A method of providing a self-adhesive mouldable pad comprises mixing: a) a first component comprising room temperature vulcanising silicone composition; and b) a second component, one of the first and second components comprising a moist, powdered filler, and the other of the first and second components comprising a hydrolysable cross-linking agent, to produce a self-adhesive RTV silicone elastomer composition, applying the RTV moisture cure silicone elastomer composition to a substrate, and moulding it by hand to form a pad.

The present invention provides a method of using a hand-mouldable self-adhesive silicone elastomer composition, which readily cures and which can easily be moulded by the consumer into a wide variety of shapes, to form padding, cushioning or grip enhancing areas on the external surfaces of a large variety of products, equipment and machinery.

Hand mouldable RTV (Room Temperature Vulcanising) silicone compositions are known in the art (U.S. Pat. No. 3,943,091; GB2403723), and typically comprise either two part condensation or addition cure compositions. Compositions of this type have in the past been formulated primarily for mould making applications, where the elastomer is moulded onto a substrate to form a cast of the object, and then removed when cured to provide a mould for replication of the substrate. Such compositions are used in applications such as: rapid prototyping; reproduction of figurines, collectibles, jewellery, candles, and artefacts; creation of silicone rubber pads for transfer printing; and architectural fabrication. In all of these applications, the ability of the cured silicone elastomer to release cleanly from the substrate is crucial, and thus the composition should be non-adhesive.

There are many cases in which products and equipment of all kinds could be improved for specific needs of individual consumers if they could easily add an (optionally) permanent, durable and waterproof cushioning to their products and equipment. Reasons to add this cushioning might be to form a protective layer for example in a vice, to dampen noise or vibration, to add grip to a surface or to form a waterproof, flexible seal. Added cushioning might also be to increase safety by padding sharp or dangerous parts of products, equipment and machinery or may function as a marker or as a sensory element for visually impaired. There are many cases in which products are purchased with areas which are padded or cushioned, and these preformed custom pads brealk or get lost. Replacing such custom padding is not easy, and so the present invention allows consumers an easy and convenient way to form self-adhesive padding and cushioning on their products as needed. A key advantage is that pads and cushions can be formed to any shape or size as necessary.

We have now discovered that self adhesive, hand mouldable elastomers may also be used for the production of a composition which may be moulded by the consumer to produce a variety of different products. This invention is based on a two part RTV silicone composition. Compositions of this type are well known in the art. Once mixed completely, this composition may be moulded into any three dimensional shape, or may be moulded around other three dimensional objects to adapt or modify them. Once the desired shape is achieved, the composition will hold its shape without slump or flow during cure, and complete and consistent cure may be achieved, even for very thick profiles of 20 cm or more.

U.S. Pat. No. 4,696,842 describes the use of a sheet of polymeric material to produce a customisable hand grip for sports implements, hand tools etc. However, the sheet is of a polyurethane or a copolymer, such as styrene-butadiene rubber, rather than the silicone used in the present invention, and cures in a different way.

U.S. Pat. No. 5,155,878 provides a similar material to that described in U.S. Pat. No. 4,696,842, except that it is a two-layer construction designed to allow the hand grip to be remoulded to suit a variety of different individuals. No specific material is suggested for use in preparing such hand grips.

US2002010251 describes the use of a silicone composition which includes (A) an organopolysiloxane terminated with hydroxyl groups, having a viscosity of from 25 mPa.s to 1,000,000 mPa.s at 25° C.; (B) a hydrolysable silane or a partial hydrolysis-condensation product thereof; and (C) a water-containing wet-process silica having an average particle diameter of 100 μm or smaller, which is the chief source of water for the condensation curing reaction. However, this is primarily used for sealant applications.

WO9409666, U.S. Pat. No. 5,555,584, U.S. Pat. No. 3,968,577, U.S. Pat. No. 5,733,647, U.S. Pat. No. 4,128,951, U.S. Pat. No. 4,413,429 and U.S. Pat. No. 4,433,494 describe the use of a formable elastomeric material to produce custom padding, cushioning and support mainly in footwear. The formable material disclosed in these documents is contained within a sealed envelope, is formed by the user as required, and is then cured by high temperatures through the use of either microwave or convection ovens.

U.S. Pat. No. 3,895,405 provides a formable footwear insole that is heated in the shoe using either an oven or a heatgun, is formed by the user as required, and is set on cooling.

U.S. Pat. No. 3,630,289 provides a method of shoeing a horse in which a shapeable, room temperature polymerisable composition is used to produce a hoof pad between the frog and horn wall and the horse shoe which provides a cushioning and damping effect. This hoof pad is then nailed between the hoof and the shoe. The polymers claimed include polysiloxanes, polymercaptans and polyethers. Polymers used for this purpose should not be self adhesive, as they should not bond to the hoof surface.

U.S. Pat. No. 5,266,978, U.S. Pat. No. 4,897,237 and U.S. Pat. No. 4,204,750 describe methods of producing custom padding on eyeglasses. In each of these cases, complex casting and moulding techniques are employed, and separate adhesive components used to bond the custom moulded pads to the eyeglasses. U.S. Pat. No. 5,266,978 describes the use of silicone in making the pads, but requires the application of an adhesive and primer coating to bond the pads to the eyeglasses.

Thus, the present invention consists in a method of providing a self-adhesive mouldable pad, which comprises mixing:

a) a first component comprising a room temperature vulcanising silicone composition; and

b) a second component, one of the first and second components comprising a moist, powdered filler, and the other of the first and second components comprising a hydrolysable cross-linking agent,

to produce a self-adhesive RTV silicone elastomer composition, applying the RTV silicone elastomer composition to a substrate, and moulding it by hand to form a pad.

The invention is further illustrated by the accompanying drawings, in which:

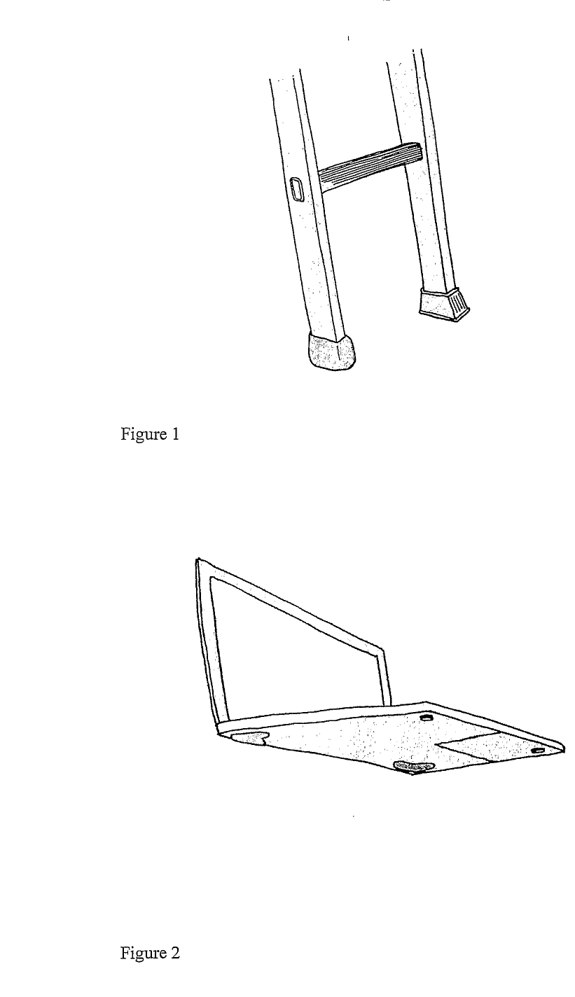

FIG. 1 shows the feet of a ladder, on one of which the original pad has been replaced by a pad using the composition of the present invention;

FIG. 2 shows a notebook computer having two pads formed of the composition of the present invention as supports on its bottom; and

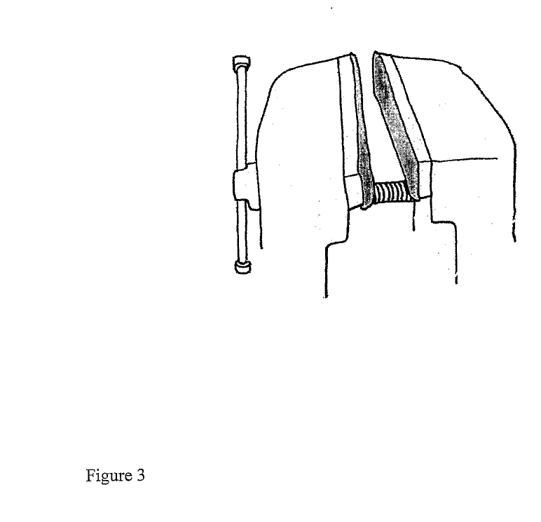

FIG. 3 shows a vice having two pads formed of the composition of the present invention on its gripping surfaces.

The components used in the present invention may be packaged in a two part package, one part containing the first component, and the other containing the second component, together with associated instructions for use, and possibly ideas for using the material.

It is an advantage of the invention that a wide range of consumers will be able very easily to customize and improve their products and equipment without the need for any tools or equipment, power supply, high temperatures or solvents. In fact only the composition of the present invention and the user's fingers are needed.

It is another advantage of the invention that the composition is self-adhesive. It will bond permanently (unless purposely cut off) to a wide range of substrates including but not limited to wood, metal, glass, ceramics and plastics.

It is another advantage of the invention, that the consumer is able to remove (by simply cutting and prising off) and/or replace customisations they have made without damaging the original surface.

The composition is comfortable at a wide range of temperatures. It can be formed and cured at room temperature, and can be used to customize products/equipment for very hot and very cold environments without any change in state.

A further advantage of the invention is that the composition is temperature resistant. It can be applied easily by users to surfaces that become very hot for protection and safety for example on equipment and machinery, e.g. cooking equipment or motor vehicle exhaust pipes. In very cold conditions, the temperature resistant nature of the composition of the present invention becomes an advantage, giving users the opportunity to improve workability of equipment in these conditions—e.g. by applying to metal tools they can be used more comfortably without gloves.

These benefits are achieved by formulating a package comprising a self adhesive, two part room temperature vulcanising elastomer. The two components of the elastomer are conveniently and easily mixed and moulded by hand to any desired shape and, in the uncured form, adhere to a wide range of substrates such as wood, metal, glass, ceramic and plastic. Once moulded, the elastomers will hold their shape exactly during cure without slump or flow, and provide rapid and consistent deep section cure at room temperature cured elastomer is a non tacky elastomeric material with excellent tactility.

The package of the invention utilises a self adhesive, two part room temperature vulcanising silicone elastomer. The overall formulation includes a hydroxy terminated polyorganosiloxane, a tri or tetra functional hydrolysable silane crosslinker where the functional groups are selected from a group comprising alkoxy groups, alkenoxy groups, ketoxime groups and acyloxy groups, and one or more fillers, optionally containing water. The formulation may optionally contain other components such as a curing catalyst, trimethylsilyl terminated polyorganosiloxane, adhesion promoters, functional additives such as pigments, including environmentally sensitive pigments such as thermochromic or pH-sensitive dyes, or thermally or electrically conducting fillers, fragrances etc. These components can be packaged in a number of alternative formats to provide a convenient to use two part system.

In a preferred formulation, the first component comprises a hydroxy-terminated polyorganosiloxanie, all effective quantity of a curing catalyst and one or more fillers optionally containing at least 5% by weight of water. The second component comprises hydroxy-terminated polyorganosiloxane, and a hydrolysable crosslinker. The second component may also optionally contain adhesion promoters, trimethylsilyl terminated polyorganosiloxane and/or additional fillers which must be dry. Other additives may be included in either component with the proviso that any water containing additives must be included in the first component.

In an alternative formulation, the first component comprises a hydroxy-terminated polyorganosiloxane, and one or more fillers optionally containing at least 5% by weight of water. The second component comprises an effective quantity of a curing catalyst, and a hydrolysable crosslinker. The second component may also optionally contain adhesion promoters, trimethylsilyl terminated polyorganosiloxane and/or additional fillers which must be dry. Other additives may be included in either component with the proviso that any water containing additives must be included in the first component.

In a further formulation, the first component comprises a hydroxy-terminated polyorganosiloxane and one or more fillers optionally containing at least 5% by weight of water, whilst the second component includes the hydrolysable crosslinker. The second component may also optionally contain an effective quantity of a condensation catalyst, adhesion promoters, trimethylsilyl terminated polyorganosiloxane and/or additional fillers which must be dry. Other additives may be included in either component with the proviso that any water containing additives must be included in the first component.

In yet another formulation, the first component comprises hydroxy-terminated polyorganosiloxane, the hydrolysable crosslinker, adhesion promoters, and optionally one or more fillers which must be dry. The second component comprises one or more fillers containing at least 5% by weight of water. These fillers may optionally be dispersed in a trimethylsilyl terminated polyorganosiloxane for ease of handling. Other additives may be included in either component with the proviso that any water-containing additives must be included in the second component. In this formulation, the first component must be packaged in an airtight container to prevent premature cure of the material. In this formulation, the filler in the second component must contain at least 5% water in order to ensure rapid deep section cure of the material.

The polyorganosiloxane preferably comprises a material of general formula HO—(R¹R²SiO)ₙ—H, where R¹ and R² are any monovalent hydrocarbon group such as alkyl radicals of 1 to 8 carbon atoms; mononuclear aryl radicals such as phenyl, methyl phenyl; cycloaluyl radicals such as cyclohexyl; and/or halogenated monovalent hydrocarbon radicals such as 3,3,3-trifluoropropyl; and n is a number such that the viscosity of the polymer lies in the range 25 mPa.s to 1,000,000 mPa.s at 25° C.

The hydrolysable crosslinker preferably comprises a hydrolysable silane of general formula RₙSiX₍₄₋ₙ₎, wherein R represents a monovalent hydrocarbon group having from 1 to 12 carbon atoms; X represents a ketoxime group, an alkoxy group, an alkenoxy group or an acyloxy group; and n represents 0, 1 or 2, or a partial hydrolysis-condensation product thereof. Examples include, but are not limited to: hydrolysable silanes having a ketoxime group, e.g., dimethyldi(butanoxime)siiane, methyltri-(butanoxime)silane, vinyltri(butanoxime)silane, phenyltri(butanoxime)silane, propyltri(butanoxime)silane, tetra(butanoxime)silane, 3,3,3-trifluoropropyl-tri(butanoxime)silane, 3-chloropropyltri(butanoxime)silane, methyltri(propanoxime)-silane, methyltri(peltanoxime)silane, methyltri(isopentanoxime)silane, vinyltri-(cyclopentanioxime)silane and methyltri(cyclohexanoxime)silane; hydrolysable silanes having an alkoxy group, e.g., dimethyldimethoxysilane, methyltrimethoxysilane. vinyltrimethoxysilane, phenyltrimethoxysilane, methyltriethoxysilane, tetramethoxysilane and tetraethoxysilane; hydrolysable silanes having an alkenoxy group, e.g., vinyltripropenoxysilane and phenyltripropenoxysilane; and hydrolysable silanes having an acyloxy group, e.g., methyltriacetoxysilane, ethyltriacetoxysilane, phenyltriacetoxysilane, vinyltriacetoxysilane and tetraacetoxysilane.

The curing catalyst may be selected from a wide range of options including organometallic compounds, aminoalkyl-substituted alkoxysilanes, amine compounds, salts of the amine compound, quaternary ammonium salts, alkali metal lower fatty acid salts, dialkylhydroxylaimines, silanes containing a guanidyl group, or siloxanes containing a guanidyl group, as is well known in the art.

Adhesion promoters may be compounds containing at least one alkoxysilyl, amino, epoxy, hiydrosilyl, acrylic or a hydroxysilyl group, or a mixture of these. PrefelTed promoters include trimethoxysilanes such as 3-methacryloxypropyltri-methoxysilane, 3-glycidoxypropyltrimethoxysilane, aminopropyltrimethoxysilane, and alkyl or aryltrimethoxysilalnes.

The filler may comprise a non reinforcing filler such as talc, calcium carbonate, wood powder, wheat flour, or an extending filler such as precipitated or famed silica, or carbon black. More specifically, examples of such fillers include: calcium carbonate (such as dry ground grades of calcium carbonate, wet ground grades of calcium carbonate, beneficiated grades of calcium carbonate, precipitated grades of calcium carbonate, surface treated grades of calcium carbonate); kaolin and other clay-based minerals (such as water fractionated clays, air floated clays, delaminated clays, calcined clays, surface treated clays); talc (such as dry ground talc, beneficiated ground talc, calcined talc, surface-treated talc); quartz and silica, including natural silicas (such as crystalline silica, fused silica, microcrystalline silica, microcrystalline novaculite, diatomaceous silica, perlite) or synthetic silicas (such as fumed silica, precipitated silicas); mica (including ground grades of mica, white grades of mica, surface-modified grades of mica, metal-coated mica grades); metal oxides and other compounds (such as titanium dioxide, alumina trihydrate, wollastonite, barium sulphate, antimony oxide, magnesium hydroxide, calcium sulphate, anhydrous calcium sulphate, dihydrate calcium sulphate, feldspar and nepheline syenite); microspheres, solid microspheres, hollow microspheres (such as coated hollow microsphere fillers, metalite aluminlum microspheres, metalite silver microspheres, magnetisable microspheres, hybrid composite microsphere fillers, mini-microspheres, polymer-encapsulated gas microspheres); synthetic silicates (such as aluminium silicate, mullite, sillirnanite, cyanite, andalusite, synthetic alkali metal aluminosilicates, calcium silicate, zirconium silicate); carbon black (such as furnace black fillers, thermal black fillers); organic fillers (such as bagasse fillers, coconut hull/fibre fillers, cork fillers, corn cob fillers, cotton-based fillers, gilsonite fillers, nutshell flour fillers, rice hull fillers, sisal/hemp fillers, soybean fillers, starch fillers, wood flour); glass, metals and any solid polymer.

The filler may also include functional additives such as pigments, including environmentally sensitive pigments such as thermochromic or pH-sensitive dyes, thermally insulating fillers, or thermally or electrically conducting fillers. The moist filler must have a residual moisture content of no less than 1%, preferably no less than 5% by weight. There is no specific limitation on the maximum moisture content of the filler; however in general, the maximum moisture content would normally be no more than 25% by weight. The moisture content is more preferably from 5% to 15% by weight. Where varied texture and surface characteristics are required e.g. to achieve increased ‘grip’ or ‘non-slip’ or aesthetic variety, loose powders/particles may be supplied and pressed into the surface by the user. For this same purpose, surface moulds may be supplied and pressed into the surface by the user to emboss a texture, or to brand a product.

These formulations provide easily mouldable, self adhesive elastomers that cure rapidly and consistently in deep section at room temperature. Similar formulations are known in the art (US2002010251, U.S. Pat. No. 5,346,940) but they are formulated primarily for industrial applications such as forming gaskets or as sealants or coating materials. They have never been used for the applications envisaged by this present invention or been formulated and packaged for the easy, safe and convenient use by non-experts in a consumer environment.

The self adhesive, two part room temperature vulcanising silicone elastomer, may be packaged and delivered to the consumer in a number of straightforward and user-friendly ways. In the simplest format, the two components may be supplied in simple resealable containers such as screw top jars. The user simply mixes appropriate, e.g. equal or approximately equal, quantities of the two components, kneads by hand to ensure complete mixing, and then moulds to shape for the desired application. Optionally, the two components may be coloured with different pigments to assist the user in determining when a complete mix has been achieved. Alternatively, the two components may be packaged in premeasured portions, for example in a blister pack, in order to simplify measurement of the correct doses of each component. The two components may also be packaged in tubes such as those typically used for sealants, or squeezable tubes similar to toothpaste tubes. This latter packaging is particularly desirable for the alternative formulation described above where the first component must be stored in an airtight container. The components may also be packaged in laminated layers in sheets, or in concentric layers, and suitable portions may be cut off by the user and kneaded by hand to form the curable elastomer.

The cure time and consistency of cure is unaffected by the size or thickness of the object moulded. For example, objects with a cross section of up to 170 mm have been prepared which cure completely and consistently in the same time as objects of much smaller cross section. In principle, objects of any size could be prepared without compromise to cure speed or consistency.

The ease of handling of these compositions and their ability to adhere to many substrates opens up a very wide range of applications for the invention in both consumer and industrial markets. The compositions can be used by end-users to adapt and modify existing products to their individual and specific needs, or to create new products. For example, the pad may be a thermally insulating pad, a vibration absorbing pad, an injury reducing pad, a non-slip pad, a scratch preventing pad, a noise reducing pad, a non-slip pad, or a grip-enhancing pad. The invention can be used in applications as areas such as (but not limited to):

1. to soften a hard surface to prevent it causing damage to another surface

(e.g. bike rack, ladder end, furniture ends etc)

2. to cover a hot surface for safety

(e.g. on exhaust pipe of motorbike, or other hot pipes)

3. to soften a hard surface for safety

4. to absorb shock and noise

(e.g. pad on inside of door jamb of slamming door)

5. to soften a hard surface for comfort.

More specifically, the compositions can be used for:

Customising and personalising objects, e.g. tools and handles made more comfortable/easy to hold/more individual, shaping things to fit individuals, making things bigger to fit,

Providing grip and support, e.g. forming it around taps etc makes them easier to turn, forming it on any object provides an area comfortable and easy to grip, better grip on sports equipment, on pedals and machinery, as well as on flooring and wet areas.

Repairing and modify objects, e.g. emergency leak repairs, patching providing a waterproof seal, as a filler, as a gap filler for pest control, as an adhesive, replacing missing parts.

Providing protection, e.g. softening and cushioning edges, comers and surfaces, cushioning ropes/straps, insulating wiring, leveling and softening ends of furniture, dampening noise, insulating things that get hot.

Providing physical markers, e.g. on ropes, cables and pipes, or tactile markers for the visually impaired.

As a creative material, e.g. for making useful things, e.g. made to fit parts or household items, as a children's play material, costumes and masks, furniture, arts and crafts and hobby material and for making pencil erasers.

As an adhesive, to stick things together where the support it will provide is also an advantage.

Particularly preferred applications of the present invention include those where the substrate to which the composition is applied is: domestic, office or school fixture; household electrical appliances; a ladder; a wall behind an opening door; walking aids; a roof or bicycle rack; a clamp or vice; the sole or heel of a shoe.

For example, in the case of furniture, where the fixture has a leg, a pad may be formed on (or applied to) the end of the leg to prevent it from damaging the surface on which it rests. Similarly, a pad may be formed on (or applied to) an end of a ladder, either to avoid damage to the surface on which the ladder rests or to improve its grip to that surface. A pad may be formed on the ends of a walking aid to prevent damage to the surface on which it is used.

In the case of a wall, a pad may be formed on the wall to prevent it being damaged by a regularly opening door. In the case of car roof racks or bicycle racks, a pad may be formed on a hard component to prevent either damage to the car or to the objects it is carrying.

In the case of clamps and vices, a pad may be formed on the inside clamping surface to prevent damage to the object being clamped. On the hard sole or heel of a shoe, a pad may be formed to protect flooring.

Other particularly preferred applications of the present invention include those where the substrate to which the composition is applied is: a motor vehicle exhaust pipe; a pipe carrying hot liquids; a hot water tank or boiler; a radiator; a tap; tea and coffee pots; a protruding engine/machine part on a vehicle; rigging, or sharp protruding parts on a boat; a low beam, bar or post; a skirting board; a bath; a wash basin.

In the case of an exhaust pipe, a pipe carrying hot liquids, a hot water tank, boiler, radiator or tap, a pad may be formed on the external surface for insulation and safety purposes.

In the case of tea and coffee pots, a pad may be formed on the base external surface to prevent damage to the surface it is rested on.

In the case of protruding engine or machine part on a vehicle, and rigging or sharp protruding parts on a boat, a pad may be formed on these parts to reduce injury on impact, and to reduce snagging of sails and other parts.

Similarly, in the case of a low beam or horizontal post in a building, a pad may be formed on the beam or post to reduce injury on impact. A pad may be formed on skirting board, bathtubs and basins for the same reason.

Other particularly preferred applications of the present invention include those where the substrate to which the composition is applied is: a door; a speaker or other audio equipment; a gun stock; A toilet seat and lid; a clothes hanger; the underside of a cutting mat or chopping board; the underside of a rug or floor mat; computer equipment; a bike or buggy pedal; a bath or shower.

In the case of a door, a pad may be applied between the door and the door jamb to prevent noisy slamming. A pad may be formed on a toilet seat and lid for the same reason.

In the case of speakers and other audio equipment, a pad may be formed to absorb vibration. Similarly, in the case of a gun stock, a pad may be formed to absorb impact.

In the case of cutting mats, chopping boards and rugs and mats and computer equipment, a pad may be formed on the underside to prevent them from slipping and moving easily on the surfaces on which they rest.

In the case of a clothes hanger, pads may be formed on the surface to prevent the garment from slipping off easily.

In the case of a bicycle or buggy pedal, a pad may be formed to increase the grip the users foot has to the pedal. Similarly, in the case of the bath or shower, pads may be formed to increase the grip the user has on the surface and provide surer footing.

Other particularly preferred applications of the present invention include those where the substrate to which the composition is applied is: prosthetics; furniture; a bike saddle; a hard seat; footwear; a wall on which things need to be pinned.

In the case of prosthetics, a pad may be formed on the surface where the limb meets the prosthetic for the user's increased comfort. Similarly on hard seating or bicycle saddles, pads may be formed for increased cushioning and comfort.

In the case of footwear, a pad may be formed on the internal surface of the shoe for increased support, vibration absorption and comfort.

In the case of the wall on which things need to be pinned, a pad may be formed directly on the wall, which notices or displays can be easily pinned on.

The preparation of the compositions used in the invention is further illustrated by the following non-limiting Examples.

### EXAMPLES

The procedure for Examples 1-7 below is as follows:

The powder mix (part b), comprising filler and optional pigment, was premixed as a dry powder. The silicone polymer was then weighed and kneaded by hand into the powder mix for approximately 3 minutes to form a consistent compound that was dry to the touch and no longer tacky. The compound was then shaped for the desired application and allowed to cure. Cure was considered complete when the shaped polymer could no longer be reshaped and had reached a consistent hardness.

### Example 1

(a) Polymer: Travis Perkins Branded OEM Frame Silicone Sealant

(b) Filler: Mix of wheat flour (moisture content about 11% by weight) and wood powder (moisture content about 6% by weight) in the proportion 55% Flour/45% Wood powder by weight

Ratio Polymer:Filler 55%:45% by weight

The same wheat flour and wood powder were used in the Examples hereafter.

After compounding, the elastomer was moulded into a ball and allowed to cure. The elastomer was fully cured after three hours. This formulation was found to provide the best qualitative balance of materials properties, namely surface texture, overall material texture, durability/tear resistance and adhesion to other materials. The particle size distribution for the filler is as shown in Table 1.

TABLE 1

| Particle size (in microns) | Sample weight (%) |
|---|---|
| <038 | 03 |
| 038-053 | 11 |
| 053-075 | 05 |
| 075-106 | 11 |
| 106-125 | 17 |
| 125-212 | 22 |
| 212-300 | 14 |
| 300-425 | 06 |
| 425-500 | 06 |
| 500-600 | 02 |
| 600-710 | 01 |
| 710-850 | 01 |
| 850-1000 | 01 |

### Example 2

(a) Polymer: Travis Perkins Branded OEM Frame Silicone Sealant

(b) Filler: Wheat flour

Ratio Polymer:Filler 55%:45% by weight

After compounding, the elastomer was moulded into a ball and allowed to cure. The elastomer was fully cured after three hours. This formulation was found to provide the best qualitative performance for surface texture and overall material texture. The particle size distribution for the filler is as shown in Table 2.

TABLE 2

| Particle size (in microns) | Sample weight (%) |
|---|---|
| <038 | 05 |
| 038-053 | 04 |
| 053-075 | 05 |
| 075-106 | 27 |
| 106-125 | 34 |
| 125-212 | 23 |
| 212-300 | 01 |
| 300-425 | 00.5 |
| 425-500 | 00.5 |

### Example 3

(a) Polymer: Travis Perkins Branded OEM Frame Silicone Sealant

(b) Filler: Mix of wheat flour and wood powder in the proportion 55% Flour/45% Wood powder by weight

Ratio Polymer:Filler 55%:45% by weight

After compounding, the elastomer was moulded into a ball and allowed to cure. The elastomer was fully cured after three hours. This formulation was found to provide the best qualitative performance for durability and tear resistance. The particle size distribution for the filler is as shown in Table 3.

TABLE 3

| Particle size (in microns) | Sample weight (%) |
|---|---|
| <038 | 03 |
| 038-053 | 11 |
| 053-075 | 05 |
| 075-106 | 11 |
| 106-125 | 17 |
| 125-212 | 22 |
| 212-300 | 14 |
| 300-425 | 06 |
| 425-500 | 06 |
| 500-600 | 02 |
| 600-710 | 01 |
| 710-850 | 01 |
| 850-1000 | 01 |

### Example 4

(a) Polymer: Travis Perkins Branded OEM Frame Silicone Sealant

(b) Filler: Mix of wheat flour and wood powder in the proportion 75% Flour/25% Wood powder by weight

Ratio Polymer:Filler 55%:45% by weight

After compounding, the elastomer was moulded into a ball and allowed to cure. The elastomer was fully cured after three hours. This formulation was found to provide the best qualitative performance for adhesion to other materials. The particle size distribution for the filler is as shown in Table 4.

TABLE 4

| Particle size (in microns) | Sample weight (%) |
|---|---|
| <038 | 03 |
| 038-053 | 05 |
| 053-075 | 07 |
| 075-106 | 26 |
| 106-125 | 10 |
| 125-212 | 30 |
| 212-300 | 07 |
| 300-425 | 05 |
| 425-500 | 02 |
| 500-600 | 02 |
| 600-710 | 01 |
| 710-850 | 01 |
| 850-1000 | 01 |

### Example 5

(a) Polymer: Everflex General Purpose Acetoxy Sealant

(b) Filler: Wheat flour

Ratio Polymer:Filler 50%:50% by weight

After compounding, the elastomer was moulded into a ball and allowed to cure. The elastomer cured more rapidly than those described in Examples 1-4, with the shape of the moulded ball fixed after approximately 10 minutes and was fully cured after 40 minutes.

### Example 6

This example demonstrates the effect of the moisture content of the filler on cure performance

(a) Polymer: Travis Perkins Branded OEM Frame Silicone Sealant

(b) Filler: Wheat flour

Ratio Polymer:Filler 50%:50% by weight

Flour particles were dried 3 times in the oven at 170° C. for 2 hours each time.

Two identical mixes were made; composition A using dried filler and composition B using non-dried filler. Each composition comprising 15 g silicone and 15 g filler, was mixed for 3 minutes in a similar manner, and was allowed to cure in the same conditions.

Composition A was found to be much stiffer and less malleable and also less sticky/less adhesive than composition B. Composition A was not at all tacky to touch while composition B was slightly tacky but still convenient to work. Composition B was also much smoother when shaped while the surface of composition A tended to crack when being moulded.

Table 5 compares the properties of compositions A and B during cure.

TABLE 5

| | Time after | |
|---|---|---|
| Composition A | mixing/min | Composition B |
| Still malleable | 10 | Still malleable |
| A little tougher but still | 40 | Getting dryer |
| malleable | | |
| Getting dryer, cracks | 60 | Getting dryer |
| significantly when worked | | |
| Still malleable but very cracked | 120 | Curing and beginning to |
| | | retain shape when |
| | | worked |
| Still malleable but very cracked; | 150 | Curing and beginning to |
| cracks cannot be removed by | | retain shape when |
| further working | | worked |
| Limited reshaping possible; | 180 | Cannot be reshaped. |
| composition heavily cracked | | |
| Beginning to retain shape | 210 | Getting tougher |
| Retaining shape but not fully | 300 | Getting tougher |
| cured | | |
| Retaining shape but not fully | 330 | Fully cured |
| cured | | |
| Cannot be reshaped, but not | 360 | Fully cured |
| fully cured | | |

The effect of drying the filler can be summarised as:

1. Makes the formulation more difficult to shape and smooth.

2. Reduces adhesiveness of formulation.

3. Extended cure times and inconsistent cure.

### Example 7

(a) Polymer: Travis Perkins Branded OEM Frame Silicone Sealant

(b) Filler: Wheat Flour

Ratio Polymer:Filler 50%:50% by weight

When mixed this composition was divided into two samples. Sample 1:3100 g and 170 mm diameter; and Sample 2: 50 g and 45 mm diameter.

In both cases the samples cured completely in 3.5 hours. After this time both samples were cut in half and were found to be completely cured throughout the sample. This experiment demonstrates that very deep section, consistent cure can be achieved with this invention. The cross sections are shown in FIG. 5.

### Example 8

In this example, a two part formulation was developed in which both components have a putty like consistency prior to mixing and curing. The formulation of the two components is as shown in Table 6:

TABLE 6

| | Component A | Component B |
|---|---|---|
| Hydroxy-terminated | 6.30 g | 6.60 g |
| polydimethylsiloxane | | |
| Sigma Aldrich 43299-7 | | |
| viscosity 18,000-22,000 cSt | | |
| (25 degrees C) | | |
| Silica (Cabot TS530) | 1.26 g | 1.9 g |
| Talc (Pumex, 200 mesh) | 9.04 g | 17.6 g |
| Flour (Tesco, plain flour) | 1.00 g | — |
| Water | 2.99 g | — |
| Dibutyltin dilaurate, 95%. | 0.43 g | — |
| Sigma Aldrich, Cat no: | | |
| 29,123-4. | | |
| Tetrapropyl orthosilicate, | — | 2.42 g |
| 95%, Sigma Aldrich 23574-1 | | |
| Tetramethoxysilane, 98% | — | 0.26 g |
| Sigma Aldrich 21,847-2 | | |
| Phenyltrimethoxysilane | — | 1.71 g |
| Fluka, 792 | | |
| Aminopropyltrimethoxysilane | — | 1.00 ml |
| Dow Corning Z-6020 Silane, | | |
| Alkoxysilane ref no: 761 687 | | |
| Pigment: LPX Vermillion, | trace | — |
| Repsil pigment | | |

Component A was prepared by preblending the water with the fillers, then in turn blending this with the hydroxy-terminated polydimethylsiloxane and then the catalyst. Component B was made in a similar way (excluding water), replacing the catalyst with the silane mixture which acts as both crosslinker and adhesion promoter. Equal parts of component A and B were then moulded together by hand. Cure was complete within 10 minutes, and the material showed good adhesion to a range of substrates including glass, wood and metal.

### Example 9

In this example, a putty like component A is blended with component B which includes both crosslinker and curing catalyst. The component formulations are as shown in Table 7:

TABLE 7

| | Component A | Component B |
|---|---|---|
| Hydroxy-terminated | 175 g | — |
| polydimethylsiloxane | | |
| Sigma Aldrich 43299-7 | | |
| viscosity 18,000-22,000 cSt | | |
| (25 degrees C) | | |
| Silica (Cabot TS610) | 875 ml | — |
| Magsil Diamond, 200 Mesh | 42 g | — |
| Water | 11.9 g | — |
| Polydimethylsiloxane | — | 4.77 g |
| Fluka, Silicone Oil DC 200, | | |
| Cat. No: 85424. | | |
| Dibutyltin dilaurate, 95%. | — | 0.43 g |
| Sigma Aldrich, Cat no: | | |
| 29,123-4. | | |
| Tetrapropyl orthosilicate, | — | 2.41 g |
| 95% | | |
| Sigma Aldrich 23574-1 | | |
| Tetramethoxysilane, 98% | — | 0.26 g |
| Sigma Aldrich 21,847-2 | | |
| Phenyltrimethoxysilane | — | 1.72 g |
| Fluka, 792 | | |
| Aminopropyltrimethoxysilane | — | 1.00 ml |
| Dow Corning Z-6020 Silane, | | |
| Alkoxysilane ref no: 761 687 | | |
| Pigment: LPX Vermillion, | trace | — |
| Repsil pigment | | |

To produce a cured elastomer, 19 g of component A was mixed with 2 ml of component B, and 1 ml of Aminopropyltrimethoxysilane (Dow Corning Z-6020 Silane). The components were mixed manually for 90 seconds and the cure observed. Complete cure of the sample took approximately two hours, with a sample working time of approximately 10 minutes. Adhesion to a range of substrates was tested and good adhesion to glass, metal and wood was observed. Complete and consistent deep section cure of the sample was achieved.

It can be seen from the Examples above that the compositions of the present invention have several advantages, specifically:

The elastomers are easily mixed and moulded by hand and are therefore usable and processable by consumers.

The elastomers adhere to most substrates. This advantage results from the formulation of the sealant which includes adhesion promoters designed for the target substrates on which the product is used. Although other hand mouldable silicone compositions are known, these are primarily formulated for mouldmaking applications, where adhesion of the cured elastomer to the substrate is undesirable.

The elastomers cure quickly and consistently at deep section at room temperature as a result of the moisture content of the filler.

1. A method of providing a self-adhesive mouldable pad, which comprises mixing:
a) a first component comprising room temperature vulcanising silicone composition; and
b) a second component, one of the first and second components comprising a moist, powdered filler, and the other of the first and second components comprising a hydrolysable cross-linking agent,
to produce a self-adhesive RTV silicone elastomer composition, applying the RTV moisture cure silicone elastomer composition to a substrate, and moulding it by hand to form a pad.

2. A method according to claim 1, in which the moist filler is present in the first component.

3. A method according to claim 1, in which the second component comprises the moist filler.

4. A method according to claim 1, in which the first component comprises a hydroxy-terminated polyorganosiloxane, an effective quantity of a curing catalyst and one or more moist fillers, and the second component comprises hydroxy-terminated polyorganosiloxane, and a hydrolysable crosslinker.

5. A method according to claim 4, in which the second component also contains one or more of adhesion promoters, and/or trimethylsilyl terminated polyorganosiloxane and/or additional fillers which must be dry.

6. A method according to claim 1, in which the first component comprises a hydroxy-terminated polyorganosiloxane, and one or more moist fillers, and the second component comprises an effective quantity of a curing catalyst, and a hydrolysable crosslinker.

7. A method according to claim 6, in which the second component also contains one or more of adhesion promoters, and/or trimethylsilyl terminated polyorganosiloxane and/or additional fillers which must be dry.

8. A method according to claim 1, in which the first component comprises a hydroxy-terminated polyorganosiloxane, the hydrolysable crosslinking agent, an adhesion promoter, and optionally one or more dry fillers, and the second component comprises one or more fillers containing at least 5% by weight of water.

9. A method according to claim 1, in which the filler contains from 1 to 25% water by weight.

10. A method according to claim 5, in which the filler contains from 5 to 15% water by weight.

11. A method according to claim 1, in which the filler comprises talc, calcium carbonate, wood powder, wheat flour, precipitated or fumed silica, or carbon black.

12. A method according to claim 1, in which the pad is a thermally insulating pad, a vibration absorbing pad, an injury reducing pad, a non-slip pad, a scratch preventing pad, a noise reducing pad, a non-slip pad, or a grip-enhancing pad.

13. A method according to claim 1, in which the substrate is domestic, office or school furniture, household electrical appliances, a ladder, a wall behind an opening door, walking aids, a roof or bicycle rack, a clamp or vice, the sole or heel of a shoe., a motor vehicle exhaust pipe, a pipe carrying hot liquids, a hot water tank or boiler, a radiator, a tap, tea and coffee pots, a protruding engine/machine part on a vehicle, rigging, sharp protruding parts on a boat, a low beam, bar or post, skirting board, bath, a wash basin, a door, a speaker or other audio equipment, a gun stock, a toilet seat and lid, a clothes hanger, the underside of a cutting mat or chopping board, the underside of a rug or floor mat, computer equipment, a bicycle or buggy pedal, the flooring of a bath or shower, prosthetics, a bike saddle, a hard seat, footwear, a wall.
